(19) United States
(12) Patent Application Publication
(10) Pub. No.: US 2025/0091667 A1
(43) Pub. Date: Mar. 20, 2025

(54) TRACK SYSTEMS WITH OFFSET CONTACT PATCHES

(71) Applicant: SOUCY INTERNATIONAL INC., Drummondville (CA)

(72) Inventor: Jeremie AUBIN-MARCHAND, St-Hugues (CA)

(21) Appl. No.: 18/890,352

(22) Filed: Sep. 19, 2024

Related U.S. Application Data
(60) Provisional application No. 63/583,971, filed on Sep. 20, 2023.

(51) Int. Cl. B62D 55/04; B62D 55/14

(52) U.S. Cl. CPC B62D 55/04; B62D 55/14

(57) ABSTRACT

A track system includes a frame, a drive wheel assembly, an idler wheel assembly, a support wheel assembly, and an endless track. The drive, idler and support wheel assemblies are rotationally connected to the frame. The support wheel assembly includes inner and outer laterally spaced wheels. The endless track, which surrounds the frame, the drive, idler and support wheel assemblies, has a longitudinal center plane defining inner and outer lateral sides. The endless track has a contact patch for engaging a ground surface. The contact patch is defined at least by the support wheel assembly that is configured such that a center point of a width of the contact patch is offset from the longitudinal center plane, and is disposed on the inner lateral side.

### CROSS-REFERENCE

The present application claims priority to U.S. Provisional Patent Application No. 63/583,971, filed Sep. 20, 2023 entitled “Track Systems with Offset Contact Patches”, which is incorporated by reference herein in its entirety.

### TECHNICAL FIELD

The present application generally relates to track systems with offset contact patches and to vehicles comprising them.

### BACKGROUND

Conventional steering systems used in many vehicles having wheels can have an inherent scrubbing rate which can be representative of the amount of tire tread being scrubbed off as the tires slide laterally during turning. This scrubbing effect can contribute to performance degradation and premature wear of the tire tread.

When conventional track systems are connected to these vehicles (e.g., for replacing the wheels), being that conventional track systems are generally wider than the original wheels, scrubbing rate can increase due to an increase of the scrub radius. This can negatively impact steering properties of the steering systems. Notably, a higher scrubbing rate can lead to an increase in friction which can adversely affect the efficiency, the control and the stability of the vehicle, and can lead to greater tread wear.

These adverse effects of increased scrubbing rate can be especially problematic for off-road vehicles such as all-terrain vehicles, due to their versatile off-road applications, demanding high steering sensitivity and adaptability across various terrains.

There is this a desire for a track system that could mitigate the above-mentioned issues.

### SUMMARY OF TECHNOLOGY

It is an object of the present technology to ameliorate at least some of the inconveniences present in the prior art.

According to one aspect of the present technology, there is provided a track system. The track system includes a frame, a drive wheel assembly, an idler wheel assembly, a support wheel assembly and an endless track. The drive wheel assembly is rotationally connected to the frame. The idler wheel assembly is rotationally connected to the frame. The support wheel assembly is rotationally connected to the frame and includes inner and outer laterally spaced wheels. The endless track surrounds the frame, the drive, idler and support wheel assemblies. The endless track has a longitudinal center plane defining an inner lateral side and an outer lateral side. The endless track has a contact patch for engaging a ground surface, the contact patch being defined at least by the support wheel assembly, where the support wheel assembly is configured such that a center point of a width of the contact patch is offset from the longitudinal center plane, and is disposed on the inner lateral side.

In some embodiments, the inner wheel of the support wheel assembly has an inner lateral point that is, from the longitudinal center plane, the laterally furthermost point of the inner wheel engaging the endless track on the inner lateral side, the outer wheel of the support wheel assembly has an outer lateral point that is, from the longitudinal center plane, the laterally furthermost point of the outer wheel engaging the endless track on the outer lateral side, and the contact patch extends between inner and outer lateral points.

In some embodiments, the inner wheel has an inner wheel width, the outer wheel has an outer wheel width, and the inner wheel width is greater than the outer wheel width.

In some embodiments, the inner wheel is laterally spaced from the longitudinal center plane by a first distance, the outer wheel is laterally spaced from the longitudinal center plane by a second distance, and the first distance is greater than the second distance.

In some embodiments, the support wheel assembly further includes an other wheel disposed on one of inner and outer lateral sides.

In some embodiments, the other wheel forms a tandem wheel assembly with a corresponding one of the inner and outer wheels of the one of inner and outer lateral sides.

In some embodiments, the other wheel is disposed on the inner lateral side, and is laterally spaced from the inner wheel.

In some embodiments, the support wheel assembly is a first support wheel assembly, and the track system further includes a second support wheel assembly rotationally connected to the frame, and longitudinally spaced from the first support wheel assembly.

In some embodiments, the track system is configured to replace a wheel of a vehicle.

In some embodiments, the vehicle is an all-terrain-vehicle.

According to another aspect of the present technology, there is provided a track system connectable to a vehicle by a suspension system defining a steering axis. The track system includes a frame, a drive wheel assembly, an idler wheel assembly, a support wheel assembly, and an endless track. The drive, idler and support wheel assemblies are rotationally connected to the frame. The support wheel assembly includes inner and outer laterally spaced wheels. The endless track, which surrounds the frame, the drive, idler and support wheel assemblies, has a longitudinal center plane defining an inner lateral side and an outer lateral side. The endless track has a contact patch for engaging a ground surface, where the contact patch is defined at least by the support wheel assembly. The support wheel assembly is configured such that a center plane of a width of the contact patch is offset from the longitudinal center plane toward an intersection of the steering axis and a ground surface.

In some embodiments, the contact patch is configured to reduce a scrub radius of the track system, the scrub radius being measured between the center plane of the width of the contact patch and the intersection of the steering axis and the ground surface.

In some embodiments, the inner wheel of the support wheel assembly has an inner lateral point that is, from the longitudinal center plane, the laterally furthermost point of the inner wheel engaging the endless track on the inner lateral side, the outer wheel of the support wheel assembly has an outer lateral point that is, from the longitudinal center plane, the laterally furthermost point of the outer wheel engaging the endless track on the outer lateral side, and the contact patch extends between inner and outer lateral points.

In some embodiments, the inner wheel has an inner wheel width, the outer wheel has an outer wheel width, and the inner wheel width is greater than the outer wheel width.

In some embodiments, the inner wheel is laterally spaced from the longitudinal center plane by a first distance, the outer wheel is laterally spaced from the longitudinal center plane by a second distance, and the first distance is greater than the second distance.

In some embodiments, the support wheel assembly further includes an other wheel disposed on one of inner and outer lateral sides.

In some embodiments, the other wheel forms a tandem wheel assembly with a corresponding one of the inner and outer wheels of the one of inner and outer lateral sides.

In some embodiments, the other wheel is disposed on the inner lateral side, and is laterally spaced from the inner wheel.

In some embodiments, the support wheel assembly is a first support wheel assembly, and the track system further includes a second support wheel assembly rotationally connected to the frame, and longitudinally spaced from the first support wheel assembly.

In some embodiments, the track system is configured to replace a wheel of the vehicle.

In some embodiments, the vehicle is an all-terrain-vehicle.

In the context of the present specification, unless expressly provided otherwise, the words “first”, “second”, “third”, etc. have been used as adjectives only for the purpose of allowing for distinction between the nouns that they modify from one another, and not for the purpose of describing any particular relationship between those nouns.

It must be noted that, as used in this specification and the appended claims, the singular form “a”, “an” and “the” include plural referents unless the context clearly dictates otherwise.

As used herein, the term “about” in the context of a given value or range refers to a value or range that is within 20%, preferably within 15%, preferably within 10%, and more preferably within 5% of the given value or range.

As used herein, the term “and/or” is to be taken as specific disclosure of each of the two specified features or components with or without the other. For example, “A and/or B” is to be taken as specific disclosure of each of (i) A, (ii) B and (iii) A and B, just as if each is set out individually herein.

For purposes of the present application, terms related to spatial orientation when referring to a track system and components in relation thereto, such as “vertical”, “horizontal”, “forwardly”, “rearwardly”, “left”, “right”, “above” and “below”, are as they would be understood by a driver of a vehicle to which the track system is connected, in which the driver is sitting on the vehicle in an upright driving position, with the vehicle steered straight-ahead and being at rest on flat, level ground.

Implementations of the present technology each have at least one of the above-mentioned objects and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects, and advantages of implementations of the present technology will become apparent from the following description and the accompanying drawings.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a left side elevation of an off-road vehicle having track systems according to embodiments of the present technology;

FIG. 2 is a right side elevation view of a front right track system of the off-road vehicle of FIG. 1;

FIG. 3 is a cross-sectional view of the front right track system of FIG. 2 taken along the line 3-3 of FIG. 2;

FIG. 4A is a schematic elevation view of a wheel connected to a suspension system of a vehicle as is known in the art;

FIG. 4B is a schematic elevation view of a conventional track system connected to a suspension system of a vehicle as is known in the art;

FIG. 5A is a schematic top plan view of the front right track system of FIG. 2;

FIG. 5B is a close-up of intermediate and trailing support wheel assemblies of the front track system of FIG. 5A;

FIG. 5C is a schematic front elevation view of the front track system of FIG. 5A connected to a suspension system of the vehicle of FIG. 1;

FIG. 6A is a schematic top plan view of a front right track system according to an alternative embodiment of the present technology;

FIG. 6B is a close-up of intermediate and trailing support wheel assemblies of the front track system of FIG. 6A;

FIG. 6C is a schematic front elevation view of the front track system of FIG. 6A connected to a suspension system of the vehicle of FIG. 1;

FIG. 7A is a schematic top plan view of a front track system according to an alternative embodiment of the present technology; and

FIG. 7B is a close-up of intermediate and trailing support wheel assemblies of the front track system of FIG. 7A.

### DETAILED DESCRIPTION

The present disclosure is not limited in its application to the details of construction and the arrangement of components set forth in the following description or illustrated in the drawings. The disclosure is capable of other embodiments and of being practiced or of being carried out in various ways. Also, the phraseology and terminology used herein is for the purpose of description and should not be regarded as limiting. The use of “including”, “comprising”, or “having”, “containing”, “involving” and variations thereof herein, is meant to encompass the items listed thereafter as well as, optionally, additional items. In the following description, the same numerical references refer to similar elements.

The present technology relates to a track system in which, a contact patch, sometimes referred to a ground-engaging area, has been offset in the lateral direction in order to improve steering properties of the vehicle to which the track system is connected, by reducing a scrub radius.

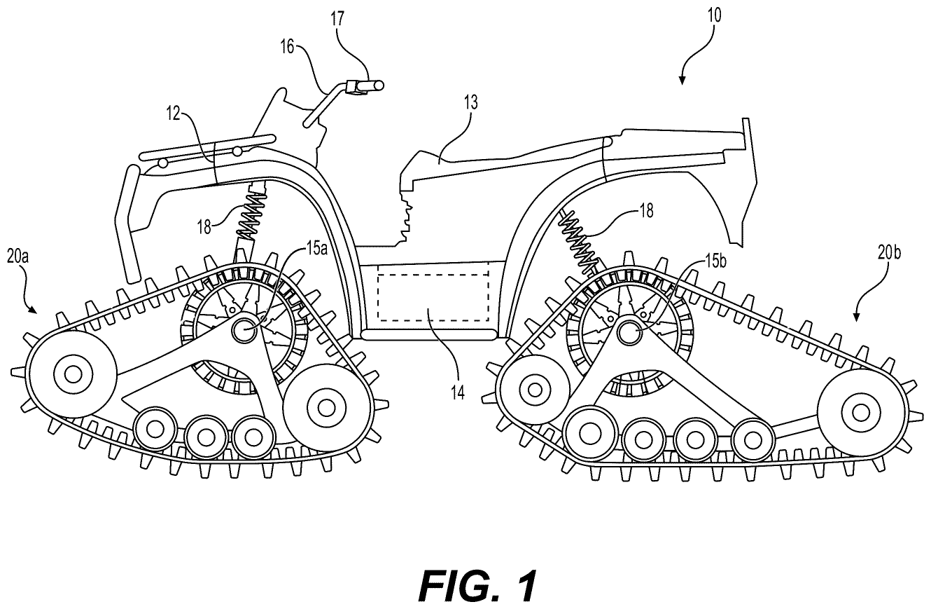

Referring to FIG. 1, the present technology will be described with reference to a vehicle 10. In the illustrated embodiment, the vehicle 10 is an off-road vehicle 10. More precisely, the vehicle 10 is an all-terrain vehicle (ATV) 10. It is contemplated that in other embodiments, the off-road vehicle 10 could be a snowmobile, a side-by-side vehicle, a utility-task vehicle (UTV) or another type of recreational vehicle. The off-road vehicle 10 has four track systems in accordance with embodiments of the present technology, two front track systems 20a, and two rear track systems 20b. In some embodiments, the off-road vehicle 10 could have more or less than four track systems.

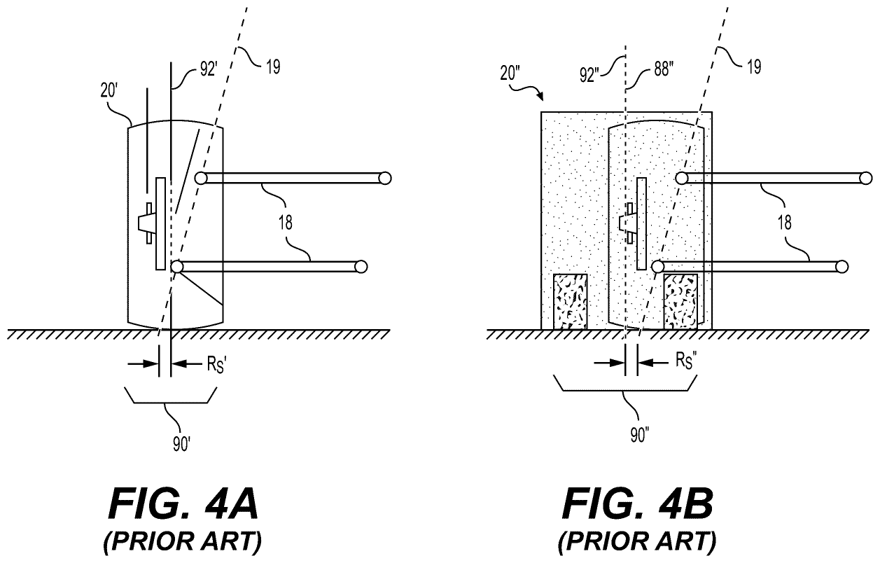

It is to be noted that the off-road vehicle 10 was typically originally designed for, and manufactured with, wheels. The front and rear track systems 20a, 20b have been retrofitted to replace the original wheels of the off-road vehicle 10 (one original wheel 20′ is shown in FIG. 4A). This may have been done for a variety of reasons such as to enhance floatation, to improve traction, etc. It is contemplated that in other embodiments, the off-road vehicle 10 could have been originally designed for and manufactured with the front and rear track systems 20a, 20b.

The off-road vehicle 10 includes a frame 12, a straddle seat 13 disposed on the frame 12, a powertrain 14 (shown schematically), a steering system 16, a suspension system 18, and the front and rear track systems 20a, 20b.

The powertrain 14, which is supported by the frame 12, is configured to generate power and transmit said power to the front and rear track systems 20a, 20b via driving axles, thereby driving the off-road vehicle 10. More precisely, the front track systems 20a are operatively connected to a front axle 15a and, the rear track systems 20b are operatively connected to a rear axle 15b. The front and rear axles 15a, 15b are, in turn, operatively connected to, and driven by, the powertrain 14. It is contemplated that in some embodiments, the powertrain 14 could be configured to provide its motive power to only the front axle 15a or to only the rear axle 15b (i.e., in some embodiments, only one of the front axle 15a and/or rear axle 15b could be a driving axle).

The steering system 16 is configured to enable an operator of the off-road vehicle 10 to steer the off-road vehicle 10. To this end, the steering system 16 includes a handlebar 17 that is operable by the operator to direct the off-road vehicle 10 along a desired course. In other embodiments, the handlebar 17 could be replaced by another steering device such as, for instance, a steering wheel. The steering system 16 is configured so that in response to the operator handling the handlebar 17, the orientation of the front track systems 20a is changed relative to the frame 12, thereby causing the off-road vehicle 10 to turn in a desired direction.

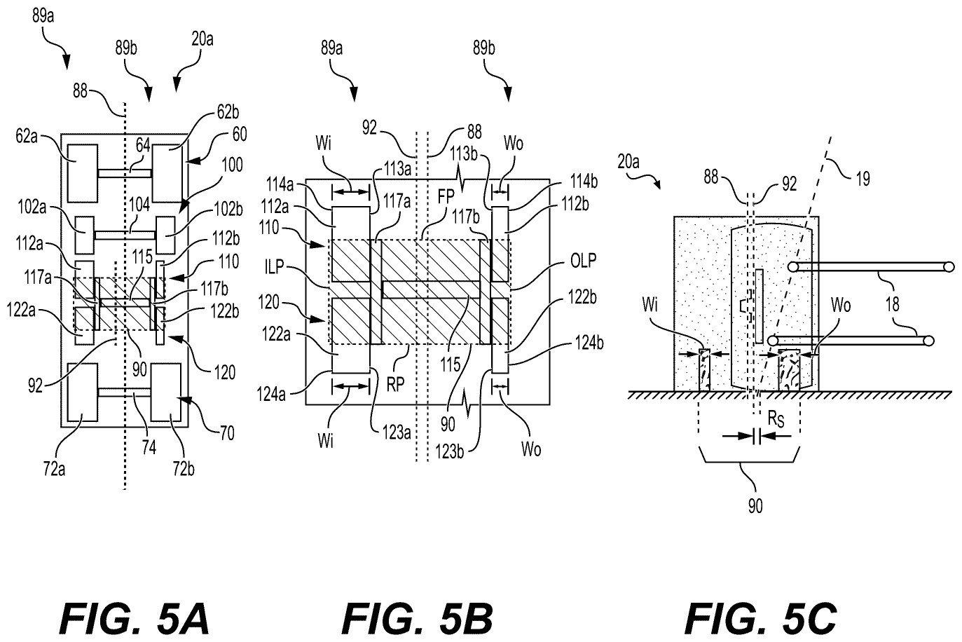

The suspension system 18, which is connected between the frame 12 and the track systems 20a, 20b allows relative motion between the frame 12 and the track systems 20a, 20b and can enhance handling of the off-road vehicle 10 by absorbing shocks and helping to maintain adequate traction between the track systems 20a, 20b and the ground. As will be described in greater detail below, for each one of the front track systems 20a, the suspension system 18 defines a kingpin axis 19 (shown in FIG. 5C). The effects of steering of the steering system 16 are applied with respect to the kingpin axis 19, such that the kingpin axis 19 may be referred to as a steering axis.

The front and rear track systems 20a, 20b are configured to compensate for and/or otherwise adapt to the suspension system 18 of the off-road vehicle 10. For instance, the front and rear track systems 20a, 20b are configured to compensate for and/or otherwise adapt to alignment settings, namely camber (i.e., a camber angle, “roll”), caster (i.e., a caster angle, “steering angle” and/or toe (i.e., a toe angle, “yaw”), which are implemented by the suspension system 18. As the off-road vehicle 10 was originally designed to use wheels instead of the front and rear track systems 20a, 20b, the alignment settings could originally have been set to optimize travel, handling, ride quality, etc. of the off-road vehicle 10 with the use of wheels. Since the track systems 20a, 20b are structurally different and behave differently from wheels, the track system 20a, 20b may be configured to compensate for and/or otherwise adapt to the alignment settings to enhance their traction and/or other aspects of their performances and/or use.

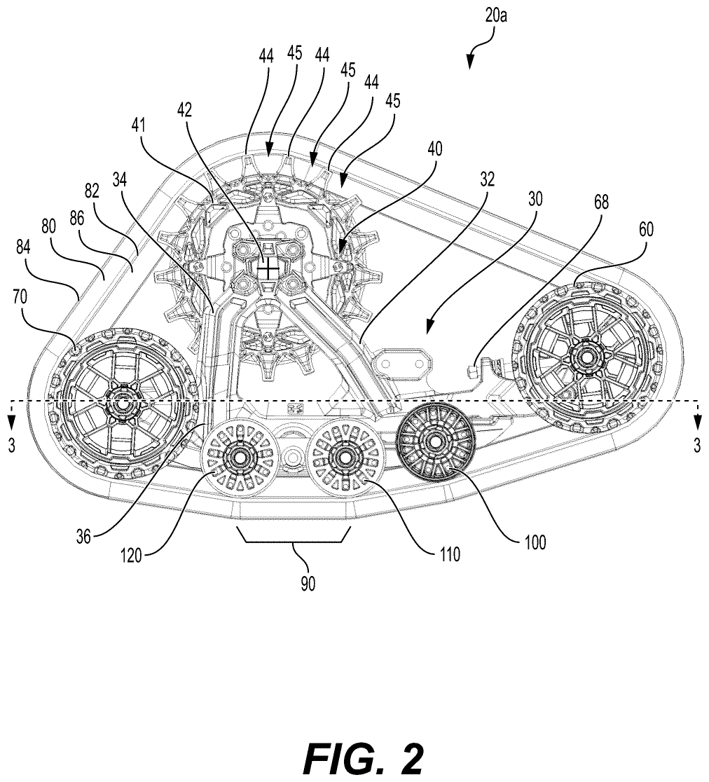

Referring to FIGS. 2, 3, 5A and 5B, a description of the front and rear track systems 20a, 20b will now be provided. Being that the present technology is particularly applicable to the front track systems 20a, only the front track systems 20a will be described in detail herewith. That said, it is understood that the present technology could also be used with the rear track systems 20b. Since the front left and right track systems 20a are generally similar (i.e., generally symmetrical about a longitudinal center plane of the off-road vehicle 10), only the front right track system 20a will be described herewith.

The track system 20a includes a frame 30, a drive wheel assembly 40, leading and trailing idler wheel assemblies 60, 70, leading, intermediate and trailing support wheel assemblies 100, 110, 120 and an endless track 80.

The frame 30 includes a leading frame member 32, a trailing frame member 34 and a lower frame member 36. The leading and trailing frame members 32, 34 are jointly connected around the front axle 15a of the off-road vehicle 10, the joint connection being positioned laterally outwardly from the drive wheel assembly 40. The leading frame member 32 extends from the joint connection, in the forward and downward directions, and connects to a front end of the lower frame member 36. The trailing frame member 34 extends from the joint connection, in the rearward and downward directions, and connects to a rear end of the lower frame member 36. The lower frame member 36, which is positioned below the joint connection, extends generally parallel to the forward direction of travel of the off-road vehicle 10. In the present embodiment, the leading, trailing and lower frame members 32, 34, 36 are integral. It is contemplated that in other embodiments, the leading, trailing and lower frame members 32, 34, 36 could be distinct members connected to one another. It is further contemplated that in some embodiments, the frame 30 could include more or fewer than three members. In some embodiments, one or more of the leading, trailing and lower frame members 32, 34, 36 could be pivotally connected to one another.

The drive wheel assembly 40, which is operatively connected to the front axle 15a of the off-road vehicle 10, is rotationally connected to the frame 30. The front axle 15a is configured to drive the drive wheel assembly 40 such that the drive wheel assembly 40 can rotate about an axis 42 that is generally perpendicular to the forward direction of travel of the vehicle. The drive wheel assembly 40 includes a drive wheel 41. The drive wheel 41 has laterally extending engaging members 44 (i.e., teeth) disposed on the circumference thereof. Recesses 45 are defined between adjacent engaging members 44. The engaging members 44 and the recesses 45 are adapted, as will be described in greater detail below, to engage with lugs 86 provided on an interior surface 82 of the endless track 80. It is contemplated that in other embodiments, the configuration of the drive wheel assembly 40 could differ without departing from the scope of the present technology.

The leading idler wheel assembly 60, which is rotationally connected to the frame 30, includes an inner wheel 62a, an outer wheel 62b and shaft 64. The shaft 64, which interconnects the inner and outer wheels 62a, 62b, is connected to the lower frame member 36 via a tensioner 68. The tensioner 68 is operable to adjust the tension in the endless track 80 by selectively moving the leading idler wheel assembly 60 toward or away from the frame 30. It is contemplated that in some embodiments, the tensioner 64 could be omitted.

The leading, intermediate and trailing support wheel assemblies 100, 110, 120 are disposed longitudinally rearwardly from the leading idler wheel assembly 60, and each one is rotationally connected to the lower frame member 36. The leading support wheel assembly 100 includes an inner wheel 102a, an outer wheel 102b and shaft 104. The shaft 104, which interconnects the inner and outer wheels 102a, 102b, is connected to the lower frame member 36. The intermediate support wheel assembly 110 includes an inner wheel 112a and an outer wheel 112b, and the trailing support wheel assembly 120 includes an inner wheel 122a and an outer wheel 122b. The intermediate and trailing support wheel assemblies 110, 120 form a tandem wheel assembly. More specifically, the inner wheels 112a, 122a are interconnected by an inner tandem 117a, whereas the outer wheels 112b, 122b are interconnected by an outer tandem 117b. The inner and outer tandem 117a, 117b are connected to a shaft 115, which is in turn connected to the lower frame member 36. It is contemplated that in other embodiments, the intermediate and support wheel assemblies 110, 120 could, like the leading support wheel assembly 100, each have their own shaft and be directly connected to the lower frame member 36.

The trailing idler wheel assembly 70 includes an inner wheel 72a, an outer wheel 72b and shaft 74. The shaft 74, which interconnects the inner and outer wheels 72a, 72b, is connected to the lower frame member 36 thereby rotationally connecting the trailing idler wheel assembly 70 to the frame 30. In some embodiments, the trailing idler wheel assembly 70 could be connected to the lower frame member 36 via a tensioner.

As best seen in FIG. 2, the leading and trailing idler wheel assemblies 60, 70 and the leading, intermediate and trailing support wheel assemblies 100, 110, 120 are positioned to have particular vertical positions relative to one another. In the illustrated embodiment, the leading and trailing idler wheel assemblies 60, 70 are disposed vertically higher than the leading, intermediate and trailing support wheel assemblies 100, 110, 120. Additionally, the leading support wheel assembly 100 is disposed vertically higher than the intermediate and trailing support wheel assemblies 110, 120, which are vertically level with one another. Thus, when the track system 20a is at rest on a flat, level, and relatively hard surface, the intermediate and trailing support wheel assemblies 110, 120 define a contact patch 90 of the endless track 80. The contact patch 90 will be described in greater detail below. It is contemplated that the vertical positioning of the wheel assemblies relative to one another may vary from one embodiment to another.

The elevation of the leading idler wheel assembly 60, and the support wheel 100 can, in some instances, assist the track system 20a in overcoming obstacles (i.e., increase approach angle) and/or assist the track system 20a in steering (i.e., minimize area of the contact patch 90). The same applies for the elevation of the trailing idler wheel assembly 70 as well (i.e., increase departure angle). In some embodiments, the leading idler wheel assembly 60 and/or the trailing idler wheel assembly 70 could bear weight, and thus could be considered to be support wheel assemblies and could assist in defining the contact patch 90.

The endless track 80 extends around components of the track system 20a, notably the frame 30, the drive wheel assembly 40, the leading and trailing idler wheel assemblies 60, 70, and the leading, intermediate and trailing support wheel assemblies 100, 110, 120.

The endless track 80 has the interior surface 82 and an exterior surface 84. The interior surface 82 of endless track 80 has the lugs 86, which are configured to engage the engaging members 44 of the drive wheel 41, and to be received in the recesses 45. The exterior surface 84 of the endless track 80 has a tread (not shown) defined thereon. It is contemplated that the tread could vary from one embodiment to another. In some embodiments, the tread could depend on the type of vehicle on which the track system 20 is to be used and/or the type of ground surface on which the vehicle is destined to travel. The endless track 80 further defines a longitudinal center plane 88 such that the endless track 80 has an inner lateral side 89a, and an outer lateral side 89b, the inner lateral side 89a being closer to the off-road vehicle 10 than the outer lateral side 89b. In some instances, the longitudinal center plane 88 of the endless track 80 could be considered to be analogous to a longitudinal center plane of the track system 20a. In the present embodiment, the endless track 80 is an endless polymeric track. It is contemplated that in some embodiments, the endless track 80 could be constructed of a wide variety of materials and structures.

The endless track 80 has the contact patch 90. As mentioned above, when the track system 20a is in an initial configuration on a flat, level and hard surface (as shown in FIG. 2), due to the configuration of the track system 20a (i.e., the relative vertical positions between the leading and trailing idler wheel assemblies 60, 70 and the leading, intermediate and trailing wheel assemblies 100, 110, 120), the contact patch 90 is generally defined by intermediate and trailing support wheel assemblies 110, 120. In other embodiments, the relative positions of one or more of the leading and trailing idler wheel assemblies 60, 70 and the leading, intermediate and trailing support wheel assemblies 100, 110, 120 could vary for changing how the contact patch 90 is defined (e.g., contact patch 90 could be defined by all three of the leading, intermediate and trailing support wheel assemblies 100, 110, 120).

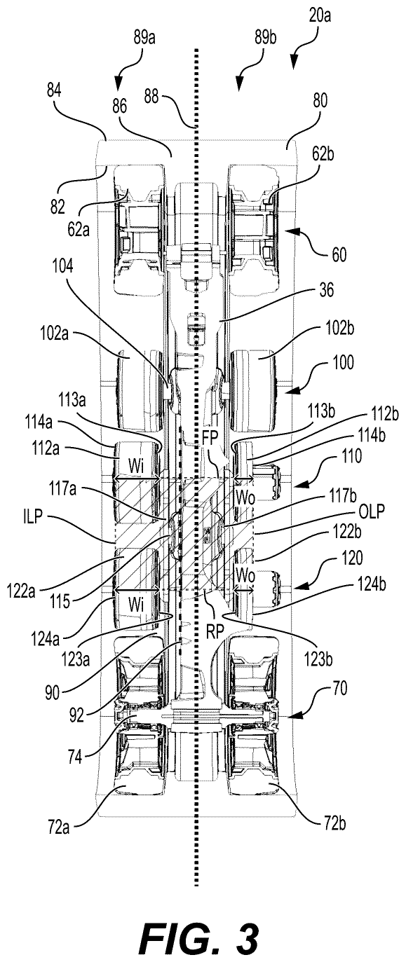

Referring now to FIG. 3, the contact patch 90 extends in the longitudinal direction and the lateral direction. In the longitudinal direction, the contact patch 90 spans from a rearmost plane RP of the trailing support wheel assembly 120 to a foremost plane FP of the intermediate support wheel assembly 110. The rearmost plane RP passes through a rearmost point of the trailing support wheel assembly 120 that engages the endless track 80. The foremost plane FP passes through a foremost point of the intermediate support wheel assembly 110 that engages the endless track 80. In the lateral direction, without being bound to any specific theory, the contact patch 90 spans from an innermost lateral plane ILP of the intermediate and trailing support wheel assemblies 110, 120 to an outermost lateral plane OLP of the intermediate and trailing support wheel assemblies 110, 120. The innermost lateral plane ILP passes through an innermost point of the intermediate and trailing support wheel assemblies 110, 120 that engages the endless track 80. The outermost lateral plane OLP passes through an outermost point of the intermediate and trailing support wheel assemblies 110, 120 that engages the endless track 80.

The contact patch 90 has a center plane 92 that is generally centered along a width of the contact patch 90. As will be described in greater detail below, according to embodiments of the present technology, the center plane 92 is configured to be laterally offset from the longitudinal center plane 88 of the endless track 80 toward the inner lateral side 89a for minimizing a scrub radius of the track system 20a, which can assist in improving steering and/or handling properties of the off-road vehicle 10.

While the rear track systems 20b are not described in detail herewith, it is worth noting that the rear track systems 20b have a different number of support wheel assemblies than the front track systems 20a. Additionally, the rear track systems 20b are configured to have longer contact patches than the front track systems 20b, which confers a given desired riding property (e.g., better traction for longer contact patches). In some embodiments, the front and rear track systems 20a, 20b could have the same contact patch.

With reference to FIG. 4A, an original wheel 20′ as known in the art, which the track system 20a is configured to replace, is shown connected to the suspension 18. The original wheel 20′ has a contact patch 90′ that has a central plane 92′. A scrub radius R_{S}′ can be measured between the central plane 92′ and the intersection of the kingpin axis 19, which is defined by the suspension 18, and the ground surface. Since the central plane 92′ is disposed laterally between the off-road vehicle 10 and the intersection of the kingpin axis 19 and the ground surface, the scrub radius R_{S}′ is a negative scrub radius.

With reference to FIG. 4B, a conventional track system 20″ as known in the art, which has been retrofitted onto the suspension 18 for replacing the original wheel 20′, is shown connected to the suspension 18. The conventional track system 20″ has a contact patch 90″ that has a central plane 92″. Being that the track system 20″ is a conventional track system 20″, the contact patch 90″ is generally laterally centered along a width of the endless track 80″, such that the central plane 92″ is generally aligned with a longitudinal center plane 88″ of an endless track 80″. As seen in FIG. 4B, being that the conventional track system 20″ is wider than the original wheel 20′, the contact patch 90″ is wider than the contact patch 90′. Additionally, since a connection of the conventional track system 20″ with the suspension 18 and with the front axle 15a generally occurs at the same lateral position, the central plane 92″ is disposed laterally further from the off-road vehicle 10 than the central plane 92′. A scrub radius R_{S}″ can be measured between the central plane 92″ and the intersection of the kingpin axis 19 and the ground surface. Since the intersection between the kingpin axis 19 and the ground surface is disposed laterally between the central plane 92″ and the off-road vehicle 10, the scrub radius R_{S}″ is a positive scrub radius. One will note that the scrub radius R_{S}″ is greater than the scrub radius R_{S}′. Thus, replacing the original wheel 20′ with the conventional track system 20″ results in an increase in scrub radius, which can negatively impact steering and/or handling properties.

With reference to FIGS. 5A to 5C, the track system 20a according to one embodiment of the present technology, which has been retrofitted onto the suspension 18 for replacing the original wheel 20′, is shown connected to the suspension 18. The track system 20a has the contact patch 90 which has the central plane 92. The track system 20a is configured so that the central plane 92 is laterally offset from the longitudinal center plane 88 toward the inner lateral side 89a of the endless track 80, and toward the intersection between the kingpin axis 19 and the ground surface. Thus, the central plane 92 is disposed laterally closer to the off-road vehicle 10 than the central plane 92″. A scrub radius R_{S} can be measured between the central plane 92 and the intersection of the kingpin axis 19 and the ground surface. Since the intersection between the kingpin axis 19 and the ground surface is disposed laterally between the central plane 92 and the off-road vehicle 10, the scrub radius R_{S} is a positive scrub radius. One will note that the scrub radius R_{S} is smaller than the scrub radius R_{S}″ due to the lateral offset between the central plane 92 and the longitudinal center plane 88. This decrease in scrub radius when compared to conventional track systems can improve steering and/or handling properties.

Referring to FIGS. 3, 5A, 5B and 5C, in the illustrated embodiment, the center plane 92 of the contact patch 90 is caused to be laterally offset from the longitudinal center plane 88 due to the configuration of the intermediate and trailing wheel assemblies 110, 120 (i.e., due to the configuration of the contact patch defining members).

The inner wheel 112a has a lateral surface 113a and a lateral surface 114a, the lateral surface 113a being closer to the longitudinal center plane 88 of the endless track 80 than the lateral surface 114a. Likewise, the outer wheel 112b has a lateral surface 113b and a lateral surface 114b, the lateral surface 113b being closer to the longitudinal center plane 88 of the endless track 80 than the lateral surface 114b. Similarly, the inner wheel 122a has a lateral surface 123a and a lateral surface 124a, the lateral surface 123a being closer to the longitudinal center plane 88 of the endless track 80 than the lateral surface 124a. Likewise, the outer wheel 122b has a lateral surface 123b and a lateral surface 124b, the lateral surface 123b being closer to the longitudinal center plane 88 of the endless track 80 than the lateral surface 124b.

The inner wheels 112a, 122a each have a width Wi. The outer wheels 112b, 122b each have a width Wo. In the illustrated embodiment, the width Wo is smaller than the width Wi. The width Wo has been decreased from a nominal size, where the nominal size corresponds to a size when the inner wheels 112a, 122a have the same width as the outer wheels 112b, 122b. In some embodiments, the nominal size could correspond to another size (e.g., nominal size could be that of the wheels of the leading support wheel assembly 100). In other embodiments, the width Wi could be increased from the nominal size. In yet other embodiments, the width Wi could be increased from the nominal size, and the width Wo could be decreased from the nominal size. Since, the inner wheels 112a, 122a and the outer wheels 112b, 122b are equally spaced from the longitudinal center plane 88, in that the lateral surfaces 113a, 123a, 113b, 123b are equally spaced from the longitudinal center plane 88, the contact patch 90 is laterally offset from the longitudinal center plane 88. Indeed, being that the contact patch 90 extends, in the lateral direction, from the lateral surfaces 114a, 124a (plane ILP) to the lateral surfaces 114b, 124b (plane OLP), and that the lateral surfaces 114b, 124b (plane OLP) are closer to the longitudinal center plane 88 than the lateral surfaces 114a, 124a (plane ILP), an area of the contact patch 90 on the inner lateral side 89a is greater than the area of the contact patch 90 on the outer lateral 89b. Thus, the center plane 92 is disposed on the inner lateral side 89a of the endless track 80.

As shown in FIG. 5C, in this embodiment, a scrub radius R_{S} can be measured between the center plane 92 of the contact patch 90, and an intersection between the kingpin axis 19 and the ground surface. Since the intersection between the kingpin axis 19 and the ground surface is disposed laterally between the central plane 92 and the off-road vehicle 10, the scrub radius R_{S} is a positive scrub radius R_{S}. Due to the lateral offset of the center plane 92 toward the inner lateral side 89a, the center plane 92 is closer to the intersection between the kingpin axis 19 and the ground surface than the center plane 92″ of the conventional track system 20″. Thus, the scrub radius R_{S} is smaller than the scrub radius R_{S}″ which can improve steering and/or handling properties.

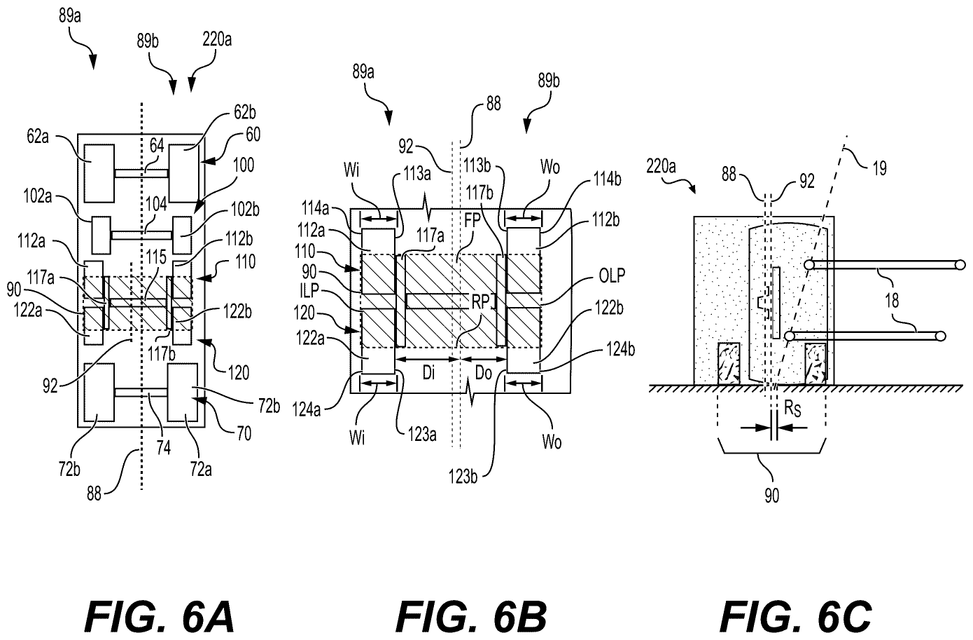

With reference to FIGS. 6A, 6B and 6C, an alternative embodiment of the track system 20a, namely track system 220a, will now be described in greater detail. Features of the track system 220a similar to those of the track system 20a have been labeled with the same reference numerals and will not be described in detail again herewith.

The track system 220a notably differs from the track system 20a in that the inner width Wi of the inner wheels 112a, 122a is equal to the outer width Wo of the outer wheels 112b, 122b. Additionally, in the track system 220a, unlike the track system 20a, the inner wheels 112a, 122a and the outer wheels 112b, 122b are not equally spaced from the longitudinal center plane 88. The inner wheels 112a, 122a are laterally spaced from the longitudinal center plane 88 by a distance D_{I}, where the distance D_{I} is measured from the longitudinal center plane 88 to the lateral surfaces 113a, 123a. The outer wheels 112b, 122b are laterally spaced from the longitudinal center plane 88 by a distance D_{O}, where the distance D_{O} is measured from the longitudinal center plane 88 to the lateral surfaces 113b, 123b. The distance D_{I} is greater than distance D_{O}. In the illustrated embodiment, the distance D_{I} has been increased from a nominal distance, where the nominal distance corresponds to the distance when the inner wheels 112a, 122a and the outer wheels 112b, 122b are equally spaced from one another. The nominal distance could, in other embodiments, correspond to another distance (e.g., nominal distance could be the distance between the longitudinal center plane 88 and the lateral surfaces of the wheels of the leading support wheel assembly 100). In other embodiments, the distance D_{O} could be decreased from the nominal distance. In other embodiments, the distance D_{O} could be decreased from the nominal distance, and the distance D_{I} could be increased from the nominal distance.

This configuration results in the contact patch 90 being offset from the longitudinal center plane 88. Indeed, being that the contact patch 90 extends, in the lateral direction, from the lateral surfaces 114a, 124a (plane ILP) to the lateral surfaces 114b, 124b (plane OLP), and that the lateral surfaces 114b, 124b are closer to the longitudinal center plane 88 than the lateral surfaces 114a, 124a, an area of the contact patch 90 on the inner lateral side 89a is greater than the area of the contact patch on the outer lateral 89b. Thus, the center plane 92 is disposed on the inner lateral side 89a of the endless track 80.

As shown in FIG. 6C, in this embodiment, the scrub radius R_{S} can be measured between the center plane 92 of the contact patch 90, and an intersection between the kingpin axis 19 and the ground surface. Since the intersection between the kingpin axis 19 and the ground surface is disposed laterally between the central plane 92 and the off-road vehicle 10, the scrub radius R_{S} is a positive scrub radius R_{S}. Due to the lateral offset of the center plane 92 toward the inner lateral side 89a, the center plane 92 is closer to the intersection between the kingpin axis 19 and the ground surface than the center plane 92″ of the conventional track system 20″. Thus, the scrub radius R_{S} is smaller than the scrub radius R_{S}″ which can improve steering and/or handling properties.

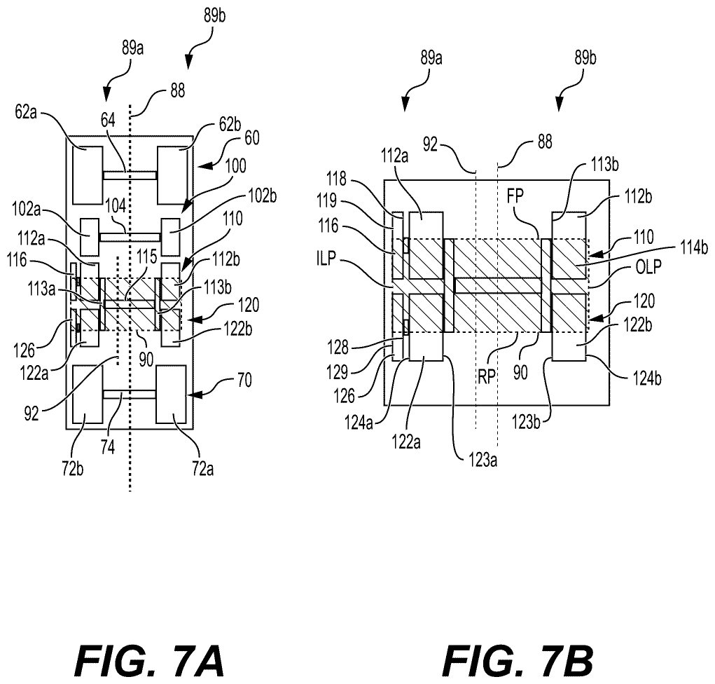

With reference to FIGS. 7A and 7B, an alternative embodiment of the track system 20a, namely track system 320a, will now be described in greater detail. Features of the track system 320a similar to those of the track system 20a have been labeled with the same reference numerals and will not be described in detail again herewith.

The track system 320a notably differs from the track systems 20a, 220a in that the intermediate support wheel assembly 110 includes a secondary inner wheel 116 laterally spaced from the inner wheel 112a, and that the trailing support wheel assembly 120 includes a secondary inner wheel 126 laterally spaced from the inner wheel 122a. The secondary inner wheel 116 has a lateral surface 118 and a lateral surface 119, where the lateral surface 118 is closer to the longitudinal center plane 88 than the lateral surface 119. Likewise, the secondary inner wheel 126 has a lateral surface 128 and a lateral surface 129, where the lateral surface 128 is closer to the longitudinal center plane 88 than the lateral surface 129. The secondary inner wheels 116, 126 have a smaller width than the width of the inner wheels 112, 122. In other embodiments, the secondary wheels 116, 126 could have the same width, or a greater width than the width of the inner wheels 112, 122.

In this embodiment, the contact patch 90 is offset from the longitudinal center plane 88 toward the inner lateral side 89a. Indeed, the contact patch 90 extends, in the lateral direction, from the lateral surfaces 119, 129 (plane ILP) to the lateral surfaces 114b, 124b (plane OLP). Since the lateral surfaces 114b, 124b (plane OLP) are closer to the longitudinal center plane 88 than the lateral surfaces 119, 129 (plane ILP) due to the presence of the secondary wheels 116, 126, an area of the contact patch 90 on the inner lateral side 89a is greater than the area of the contact patch on the outer lateral 89b. Thus, the center plane 92 is disposed on the inner lateral side 89a of the endless track 80.

Similar to what was described hereabove with respect to track systems 20a, 220a, the lateral offset of the central plane 92 of the contact patch 90 results in a smaller scrub radius than conventional track systems.

It is to be noted that in other alternative embodiments of the present technology, aspects from the different embodiments could be combined. For instance, in some embodiments, the inner wheels 112a, 122a could be wider than the outer wheels 112b, 122b, and could also be disposed laterally further from the longitudinal center plane 88. In other embodiments, other structures such as “skis” and/or “rails” may be used in track systems, and may be considered as a contact patch defining members.

Modifications and improvements to the above-described embodiments of the present invention may become apparent to those skilled in the art. The foregoing description is intended to be exemplary rather than limiting. The scope of the present invention is therefore intended to be limited solely by the appended claims.

What is claimed is:

1. A track system comprising:
a frame;
a drive wheel assembly rotationally connected to the frame;
an idler wheel assembly rotationally connected to the frame;
a support wheel assembly rotationally connected to the frame, the support wheel assembly including an inner wheel and an outer wheel, the inner wheel and the outer wheel being laterally spaced from one another; and
an endless track surrounding the frame, the drive, idler and support wheel assemblies, the endless track having a longitudinal center plane defining an inner lateral side and an outer lateral side, the endless track having a contact patch for engaging a ground surface, the contact patch being defined at least by the support wheel assembly, the support wheel assembly being configured such that a center point of a width of the contact patch is laterally offset from the longitudinal center plane, and is disposed on the inner lateral side.

2. The track system of claim 1, wherein:
the inner wheel has an inner lateral point that is, from the longitudinal center plane, the laterally furthermost point of the inner wheel engaging the endless track on the inner lateral side; and
the outer wheel has an outer lateral point that is, from the longitudinal center plane, the laterally furthermost point of the outer wheel engaging the endless track on the outer lateral side, and
the contact patch extends between inner and outer lateral points.

3. The track system of claim 1, wherein:
the inner wheel has an inner wheel width,
the outer wheel has an outer wheel width, and
the inner wheel width is greater than the outer wheel width.

4. The track system of claim 1, wherein:
the inner wheel is laterally spaced from the longitudinal center plane by a first distance,
the outer wheel is laterally spaced from the longitudinal center plane by a second distance, and
the first distance is greater than the second distance.

5. The track system of claim 1, wherein the support wheel assembly further includes an other wheel disposed on one of the inner and outer lateral sides.

6. The track system of claim 5, wherein the other wheel forms a tandem wheel assembly with a corresponding one of the inner and outer wheels of the one of the inner and outer lateral sides.

7. The track system of claim 5, wherein the other wheel is disposed on the inner lateral side, and is laterally spaced from the inner wheel.

8. The track system of claim 1, wherein:
the support wheel assembly is a first support wheel assembly, and the track system further includes a second support wheel assembly rotationally connected to the frame, the second support wheel assembly being longitudinally spaced from the first support wheel assembly.

9. The track system of claim 1, wherein the track system is configured to replace a wheel of a vehicle.

10. The track system of claim 9, wherein the vehicle is an off-road vehicle.

11. A track system connectable to a vehicle by a suspension system defining a steering axis, the track system further comprising:
a frame;
a drive wheel assembly rotationally connected to the frame;
an idler wheel assembly rotationally connected to the frame;
a support wheel assembly rotationally connected to the frame, the support wheel assembly including inner and outer laterally spaced wheels; and
an endless track surrounding the frame, the drive, idler and support wheel assemblies, the endless track having a longitudinal center plane defining an inner lateral side and an outer lateral side, the endless track having a contact patch for engaging a ground surface, the contact patch being defined at least by the support wheel assembly, the support wheel assembly being configured such that a center plane of a width of the contact patch is offset from the longitudinal center plane toward an intersection of the steering axis and a ground surface.

12. The track system of claim 11, wherein the contact patch is configured to reduce a scrub radius of the track system, the scrub radius being measured between the center plane of the width of the contact patch and the intersection of the steering axis and the ground surface.

13. The track system of claim 11, wherein:
the inner wheel of the support wheel assembly has an inner lateral point that is, from the longitudinal center plane, the laterally furthermost point of the inner wheel engaging the endless track on the inner lateral side; and
the outer wheel of the support wheel assembly has an outer lateral point that is, from the longitudinal center plane, the laterally furthermost point of the outer wheel engaging the endless track on the outer lateral side, and
the contact patch extends between inner and outer lateral points.

14. The track system of claim 11, wherein:
the inner wheel has an inner wheel width,
the outer wheel has an outer wheel width, and
the inner wheel width is greater than the outer wheel width.

15. The track system of claim 11, wherein:
the inner wheel is laterally spaced from the longitudinal center plane by a first distance,
the outer wheel is laterally spaced from the longitudinal center plane by a second distance, and
the first distance is greater than the second distance.

16. The track system of claim 11, wherein the support wheel assembly further includes an other wheel disposed on one of inner and outer lateral sides.

17. The track system of claim 16, wherein the other wheel forms a tandem wheel assembly with a corresponding one of the inner and outer wheels of the one of inner and outer lateral sides.

18. The track system of claim 16, wherein the other wheel is disposed on the inner lateral side, and is laterally spaced from the inner wheel.

19. The track system of claim 11, wherein the support wheel assembly is a first support wheel assembly, and the track system further includes a second support wheel assembly rotationally connected to the frame, and longitudinally spaced from the first support wheel assembly.

20. The track system of claim 11, wherein the track system is configured to replace a wheel of the vehicle.
